(19) United States
(12) Patent Application Publication
(10) Pub. No.: US 2024/0362532 A1
(43) Pub. Date: Oct. 31, 2024

(54) QUANTIFYING END-USER EXPERIENCES WITH INFORMATION HANDLING SYSTEM ATTRIBUTES

(71) Applicant: DELL PRODUCTS L.P., Round Rock, TX (US)

(72) Inventors: Tek Prasad Basel, Austin, TX (US); Nikhil Manohar Vichare, Austin, TX (US); Wen-Hao Zeng, Round Rock, TX (US); Nagendra-Vikas Kamath, San Mateo, CA (US)

(21) Appl. No.: 18/308,874

(22) Filed: Apr. 28, 2023

(51) Int. Cl. G06N 20/00

(52) U.S. Cl. CPC G06N 20/00

(57) ABSTRACT

An information handling system includes a storage and a processor. The storage stores a machine learning (ML) model. The processor receives first telemetry data associated with a second information handling system, and user survey data associated with the second information handling system. Based on the first telemetry data and the user survey data, the processor trains the ML model. The processor receives second telemetry data for the second information handling system. The processor executes the ML model to determine a composite score for the second information handling system.

### FIELD OF THE DISCLOSURE

The present disclosure generally relates to information handling systems, and more particularly relates to quantifying end-user experiences with information handling system attributes.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes a storage and a processor. The storage may store a machine learning (ML) model. The processor may receive first telemetry data and user survey data associated with a second information handling system. Based on the first telemetry data and the user survey data, the processor may train the ML model. The processor may receive second telemetry data for the second information handling system. The processor may execute the ML model to determine a composite score for the second information handling system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a system including multiple information handling systems and a backend server according to at least one embodiment of the present disclosure;

FIG. 2 is a flow diagram of a method for training machine learning systems to quantify end-user experiences according to at least one embodiment of the present disclosure;

FIG. 3 is a block diagram of a machine learning system according to at least one embodiment of the disclosure;

FIG. 4 is a flow diagram of a method for calculating a weighted average of an overall score for an experience of an individual with an information handling system according to at least one embodiment of the present disclosure; and

FIG. 5 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

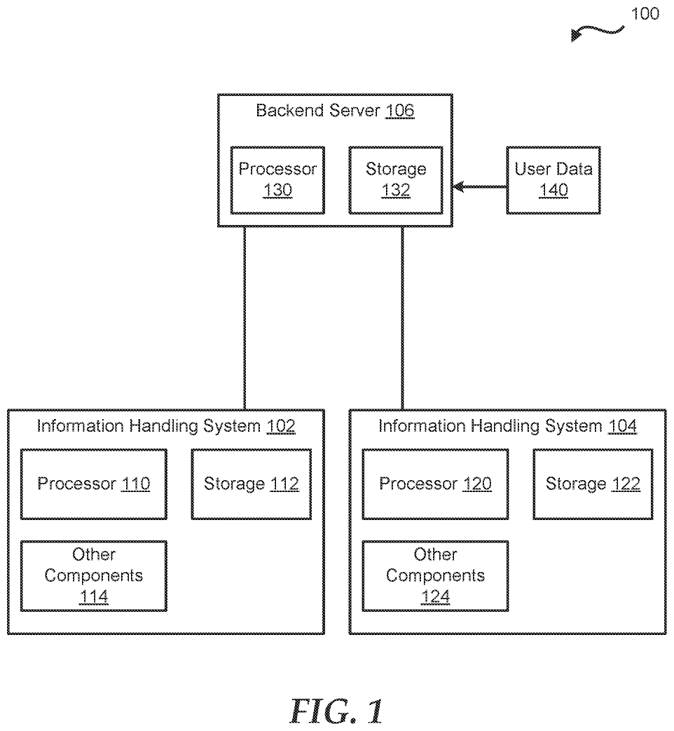

FIG. 1 illustrates a system 100 including multiple information handling systems 102 and 104 according to at least one embodiment of the present disclosure. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

System 100 includes information handling systems 102 and 104 and a backend server 106 that may communicate with each of the information handling systems. Information handling system 102 includes a processor 110, a storage 112, and other components 114. In an example, other components 112 may be any suitable components including, but not limited to, a battery, one or more additional processors, and one or more additional memory devices. Information handling system 104 includes a processor 120, a storage 122, and other components 124. In an example, other components 124 may be any suitable components including, but not limited to, a battery, one or more additional processors, and one or more additional memory devices. Backend server 106 includes a processor 130 and a storage 132. System 100 may include any suitable number of additional components or information handling systems without varying from the scope of this disclosure.

During operation of information handling systems 102 and 104, processor 110 and 120 collect telemetry data for the components in the respective information handling system. In an example, processor 110 may collect telemetry data for components 114 and store this telemetry data in storage 112. Similarly, processor 120 may collect telemetry data for components 124 and store this telemetry data in storage 122. In certain examples, processor 110 may periodically provide the telemetry data for components 114 to backend server 106. Similarly, processor 120 may periodically provide the telemetry data for components 124 to backend server 106.

In an example, processor 130 of backend server 106 may utilize the telemetry data from each information handling system to determine a user experience for that respective information handling system. For example, processor 130 may execute a machine learning (ML) model to calculate one or more composite scores for an information handling system based on the telemetry data associated with the information handling system. In an example, the composite score may correspond to a user experience with the information handling system, such as information handling system 102 or 104. Processor 130 of backend server 106 may improve a calculation of a composite score, or user experience, for an information handling system, such that proper remediations may occur within the information handling system to improve a user experience with the information handling system.

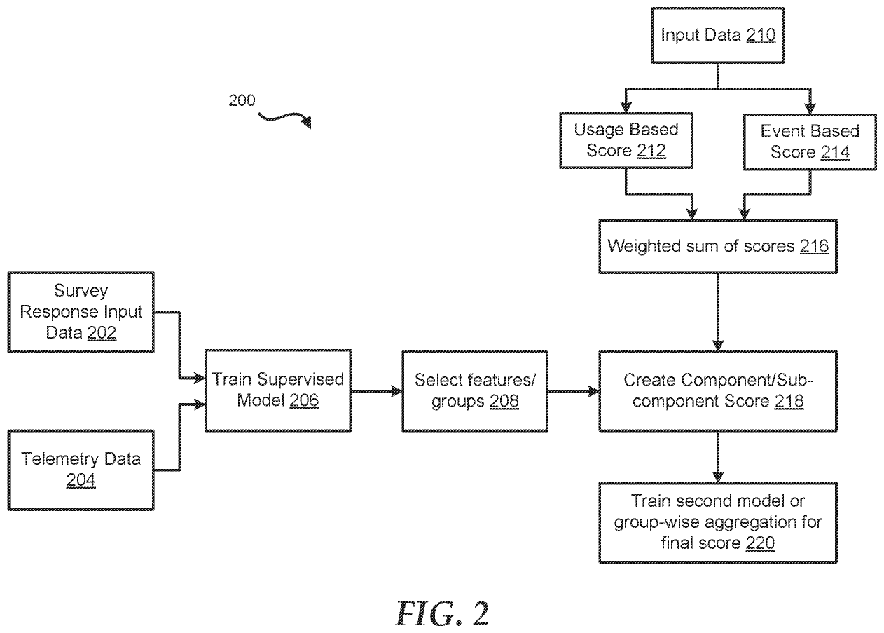

In certain examples, backend server 106 may receive user data 140. In an example, user data 140 may be any suitable data associated with one of information handling system 102 and 104. For example, user data 140 may be user survey response data from an individual associated with one of information handling system 102 and 104. In certain examples, processor 130 may utilize user data 140 and telemetry data to train the ML model to calculate the composite scores for the information handling system as will be described with respect to FIGS. 2-4 below.

FIG. 2 illustrates a flow of a method 200 for training machine learning systems or models to quantify end-user experiences as composite score of telemetry according to at least one embodiment of the present disclosure. It will be readily appreciated that not every method step set forth in this flow diagram is always necessary, and that certain steps of the methods may be combined, performed simultaneously, in a different order, or perhaps omitted, without varying from the scope of the disclosure.

At block 202, survey response input data is provided. In an example, survey response data may be any suitable data identifying an experience of a user of an information handling system. In certain examples, the experience of the user may be that the information handling system is running slow, a memory failure has occurred, other comments from the user, or the like. At block 204, telemetry data for one or more information handling systems is provided. In an example, the telemetry data may include any suitable telemetry data for an information handling system including, but not limited to, hardware telemetry data, application telemetry data, or the like. Telemetry data may also include energy usage data, health of applications, CPU core bottleneck issues, memory bottleneck issues, or the like.

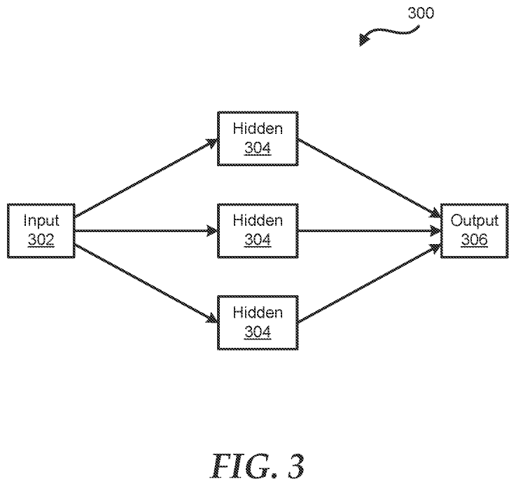

At block 206, the survey response data and the telemetry data may be utilized to train a supervised model. Based on the survey response data and the telemetry data, a supervised model may be trained. In an example, the training of supervised model may be performed in any suitable manner. Training and execution of a machine learning model will be described with respect to FIG. 3.

FIG. 3 illustrates a machine learning system 300 according to at least one embodiment of the disclosure. Machine learning system 300 includes an input layer 302, one or more hidden layers 304, and an output layer 306. Machine learning system 300 may be substantially similar to supervised model 206 and second model 220 of FIG. 2. Input layer 302 may receive any suitable data associated with an information handling system, such as information handling systems 102 and 104 of FIG. 1, and provide the data to hidden layers 304. In an example, the telemetry data may be utilized as an input data to input layer 302 of machine learning system 300. Hidden layers 304 may perform one or more operations on the input data, such as survey response data 202 and telemetry data 204, and determine a correlation between the survey response data and the telemetry data. In certain examples, hidden layers 304 may also determine a score for the information handling system based on the survey response data 202 and telemetry data 204. This score may represent a user experience based on the telemetry data.

During training of machine learning system 300, both sets of input data, such as survey response data 202 and telemetry data 204, may be utilized to correlate the telemetry data with the survey response data. During supervisory training, survey response data may be matched with the telemetry data for a corresponding information handling system. For example, an individual may provide an identification of the information handling system associated with the survey response data. In this example, the training of hidden layers 304 may enable the hidden layers to correlate telemetry data 204 to survey response data 202. Based on the training, hidden layers 304 may provide a user experience to output layer 306.

In an example, the training of hidden layers 304 may be performed in any suitable manner including, but not limited to, supervised learning, unsupervised learning, reinforcement learning, and self-learning. For example, if hidden layers 404 are trained via supervised learning, an individual may provide survey response data 202 associated with an information handling system along with telemetry data 204 for that information handling system. In an example, any machine learning model may be utilized for determining a user experience including, but not limited to, a linear regression model.

During execution of machine learning system 300, input layer 302 may receive telemetry data 204 and provide the telemetry data to hidden layers 304 in any suitable manner. For example, input layer 302 may convert telemetry data 204 into corresponding scaled values, may provide the telemetry data as received, or the like. Hidden layers 304 may then apply the received telemetry data 204 to the training data, which may provide a user experience for the associated information handling system. The determined user experience may be provided via output layer 306. Machine learning system 300 may then perform the same operations to determine user experience for each information handling system in system 100, and these user experiences may be provided by output layer 306.

Referring back to FIG. 2, after supervised model is trained at block 206, features/groups are selected at block 208. In an example, each of the features/groups may be a different telemetry data category. For example, the features/groups may include, but are not limited to, an average CPU throttle, an amount of time CPU utilization between above a particular threshold, a number of hours a battery was on a particular percentage, a health score for the information handling system, an average number of threads being executed in the information handling system, and a number of hours the information handling system is on. In an example, the lower the impact of a feature on the information handling system, the better experience a user may have with the information handling system and a better user survey response that may be received by backend server 106. In certain examples, the data may be bucketed into different components defined by SME. Features in each group may be chosen by the trained ML model and SHAP feature importance.

At block 210, input data is received. In an example, each of the components in an information handling system may include multiple types of features including, but not limited to, event-based features and periodic features. The event-based features may be discrete and sparse data, and the periodic features may be continuous numeric data. At block 212, a usage based score is determined based on the input data. At block 214, an event based score is determined based on the input data. At block 216, the usage based score and the event based score are combined as a weighted sum of scores. In an example, the weighted average of the component scores may be utilized to generate the overall score for the component. The weights may determined by the ML model based on the user's experience feedback as a target and component score as the input variables. In an example, each device score may have the contributing components and associated important features. In certain examples, the features may be ranked by statistical method based on how different they are from the normal values. Each device score may be further classified into a good, an average, or a poor category.

At block 218, component and subcomponent scores are created. The component and subcomponent scores are utilized to train a second model or group-wise aggregation for a final score at block 220. In an example, device level scores and the important features may be rolled into fleet level metrics using the aggregation method such as counting poor experience percentage, average score across all the devices and the occurrence of different features in the top rank.

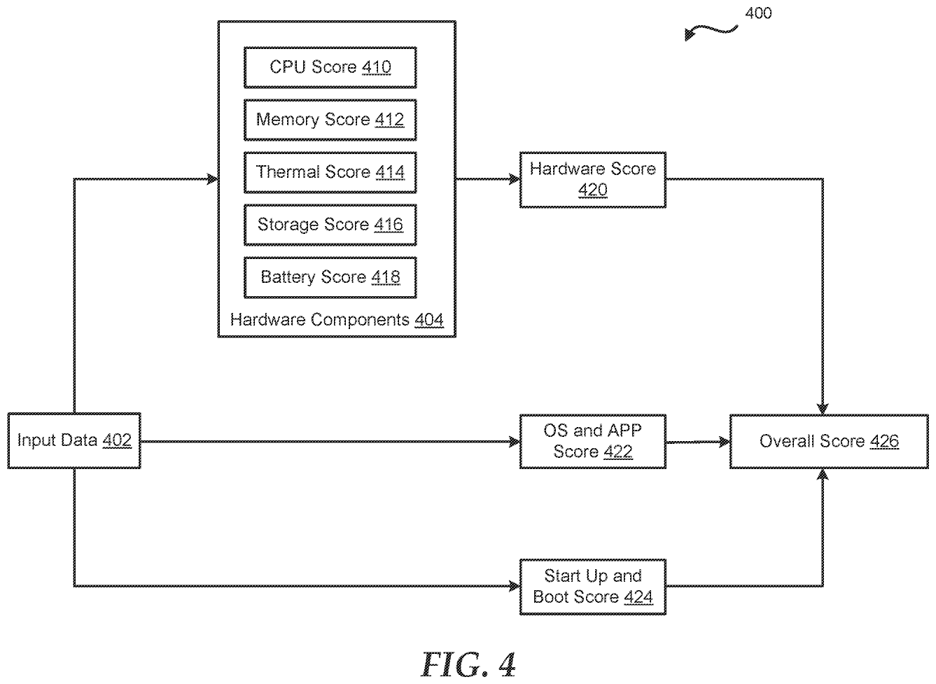

FIG. 4 illustrates a flow of a method 400 for calculating a weighted average of an overall score for an experience of an individual with an information handling system according to at least one embodiment of the present disclosure. It will be readily appreciated that not every method step set forth in this flow diagram is always necessary, and that certain steps of the methods may be combined, performed simultaneously, in a different order, or perhaps omitted, without varying from the scope of the disclosure.

At block 402, input data is received. In an example, the input data may be telemetry data and user survey data. At block 404, scores for different hardware components are determined. In an example, the hardware components may be any suitable components of an information handling system including, but not limited to, a CPU, a memory device, a storage device, a thermal device, and a battery. At block 410, a CPU score is determined. The CPU score may be determined in part based on any suitable data, such as an average CPU consumption, CPU usage above a threshold percentage, CPU time spent on CO state, an average PQL, an average threadcount in the processor, or the like. In an example, this data may be provided within the telemetry data. The CPU score may also be determined based on user survey response data 140 of FIG. 1.

At block 412, a memory score is determined. In certain examples, the memory score may be determined in part based on any suitable data including, but not limited to, an average percentage of the memory being used, an amount of time that the memory usage is above a threshold amount, such as 80%, pages per second of memory utilized, and paging percentage usage. In an example, this data may be provided within the telemetry data. The memory score may also be determined based on user survey response data 140 of FIG. 1.

At block 414, a thermal score is determined. The thermal score may be determined in part based on any suitable data, such as fan and thermistor data, or the like. In certain examples, the fan and thermistor data may include, but is not limited to, an average fam RPM, an average CPU temperature, a CPU temperature above a threshold, such as 80%, and thermal events. The thermal events may be a detection of a high hard disk temperature, a detection of a high CPU/motherboard temperatures, and thermal fan related BIOS logs. In an example, this data may be provided within the telemetry data. The thermal score may also be determined based on user survey response data 140 of FIG. 1.

At block 416, a storage score is determined. The storage score may be determined in part based on any suitable data, such as average/maximum busy percentage of drives, blocks written, write threshold percentage, or the like. In an example, this data may be provided within the telemetry data. The storage score may also be determined based on user survey response data 140 of FIG. 1. At block 418, a battery score is determined. In an example, this data may be provided within the telemetry data. The battery score may be determined in part based on any suitable data, such as raw data from a battery management unit, a processed to get estimated number of hours of runtime, a retained capacity, and a discharge session that ends below a threshold percentage, such as 30%. The battery score may also be determined based on user survey response data 140 of FIG. 1.

At block 420, a composite hardware component score is determined. In an example, the composite hardware component score may be determined based on any combination or average of the CPU score, the memory score, the thermal score, the storage score, and the battery score. At block 422, an OS and application score is determined. In certain examples, the OS and application score may be determined based on application events and OS events. The application events may be a count of foreground application crashes, a count of background application crashes, a count of foreground application hangs, a count of background application hangs, or the like. The OS events may include detection of kernel crashes. In an example, this data may be provided within the telemetry data. The OS and application score may also be determined based on user survey response data 140 of FIG. 1.

At block 424, a start up and boot score is determined. The start up and boot score may be based in part on any suitable data, such as boot logs from diagnostic data and boot events. In certain examples, the boot logs may include a startup/shutdown count, a startup/shutdown duration, a startup/shutdown degradation time, a startup/shutdown delay event count, or the like. The boot events may include startup_isdegradation, shutdown_isdegradation, a detection of a high force shutdown, power event logs, or the like. In an example, this data may be provided within the telemetry data. The start up and boot score may also be determined based on user survey response data 140 of FIG. 1. At block 426, an overall score is determined. In an example, the overall score may be determined as a weighted average of the hardware score, the OS and application score, and the startup and boot score.

Referring back to FIG. 1, the trained ML model may be stored in storage 132 of backend server 106. In an example, processor 130 of backend server 106 may execute the trained ML models to calculate composite scores for each of information handling systems 102 and 104. Based on the composite scores, processor 130 may assign a user experience to the associated information handling system. In an example, processor 130 may receive telemetry data from information handling system 102. The telemetry data may include information associated with boot events, shutdown events, or the like. For example, the telemetry data may indicate that a particular number of boot events occurred, an average number of events that delayed a shutdown, a daily average shutdown events, or the like.

During execution of the ML model by processor 130, the telemetry data may be provided as input data, the one or more hidden layers of the ML model may perform operations on the telemetry data, and the ML model may output a composite score for the information handling system 102. In an example, if processor 130 determines, via execution of ML model, determines that events in the telemetry data is substantially more than an average number of events across all information handling systems of system 100, the processor may output a low composite score for the information handling system. In certain examples, a range of composite scores may be any suitable range of values, such as 0-100. When the composite score is substantially low within the range of values, processor 130 may indicate a poor user experience for information handling system 102.

As described herein, processor 130 may utilize telemetry data and user survey response data 140 to train a ML model. Processor 130 may execute the trained ML model to calculate a composite score for an information handling system, such as information handling system 102. Processor 130 may utilize the composite score to assign a user experience, such as poor, average, or good, to the information handling system. Processor 130 may then utilize the assigned or determined user experience to provide a remediation event for information handling system 102. In an example, the remediation event may include, but is not limited to, replacing/upgrading hardware components in the information handling system, updating software in the information handling system, or the like.

In certain examples, processor 130 may provide any suitable data associated with the composite score of an information handling system, such as information handling system 102. In an example, this data may be provided in any suitable format and the data may be saved in storage 130. For example, the data may be stored in a table of storage 130. The table may include any suitable data associated with the composite score including, but not limited to, a class value, a score value, one or more feature codes, and one or more feature values. In an example, a class value may include a class, group, or bucket the device is placed in, such as good, average, or poor.

In an example, the score value may be the composite score generated by processor 130 executing the ML model on the telemetry data for information handling system 102. In certain examples, the feature code may identify one or more top features contributing to the composite score, such as a boot event count, a shutdown delay event count, and a shutdown count. The feature value may indicate the number or value associated with each of the corresponding feature codes. In an example, an individual associated with system 100, such as an information technology administrator, may utilize the data of the table stored in storage 132 to determine additional remediations beyond those provided by processor 130.

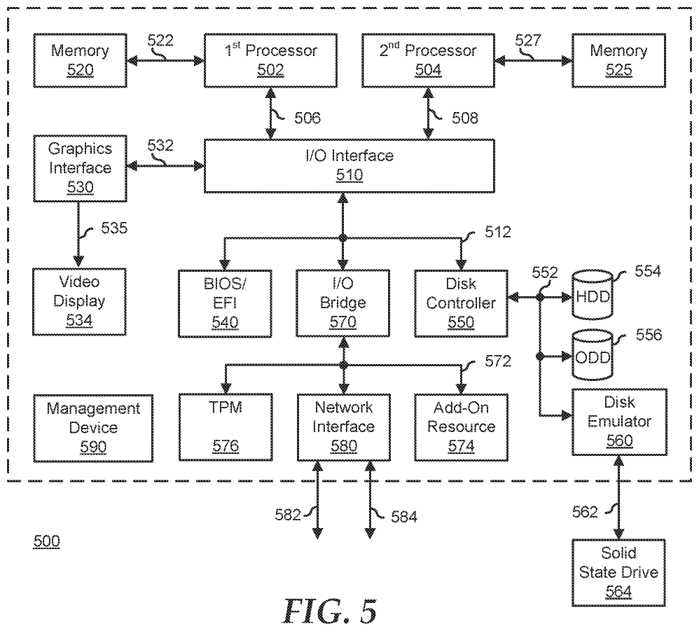

FIG. 5 shows a generalized embodiment of an information handling system 500 according to an embodiment of the present disclosure. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 500 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 500 can include processing resources for executing machine-executable code, such as a central processing unit (CPU), a programmable logic array (PLA), an embedded device such as a System-on-a-Chip (SoC), or other control logic hardware. Information handling system 500 can also include one or more computer-readable medium for storing machine-executable code, such as software or data. Additional components of information handling system 500 can include one or more storage devices that can store machine-executable code, one or more communications ports for communicating with external devices, and various input and output (I/O) devices, such as a keyboard, a mouse, and a video display. Information handling system 500 can also include one or more buses operable to transmit information between the various hardware components.

Information handling system 500 can include devices or modules that embody one or more of the devices or modules described below and operates to perform one or more of the methods described below. Information handling system 500 includes a processors 502 and 504, an input/output (I/O) interface 510, memories 520 and 525, a graphics interface 530, a basic input and output system/universal extensible firmware interface (BIOS/UEFI) module 540, a disk controller 550, a hard disk drive (HDD) 554, an optical disk drive (ODD) 556, a disk emulator 560 connected to an external solid state drive (SSD) 562, an I/O bridge 570, one or more add-on resources 574, a trusted platform module (TPM) 576, a network interface 580, a management device 590, and a power supply 595. Processors 502 and 504, I/O interface 510, memory 520, graphics interface 530, BIOS/UEFI module 540, disk controller 550, HDD 554, ODD 556, disk emulator 560, SSD 562, I/O bridge 570, add-on resources 574, TPM 576, and network interface 580 operate together to provide a host environment of information handling system 500 that operates to provide the data processing functionality of the information handling system. The host environment operates to execute machine-executable code, including platform BIOS/UEFI code, device firmware, operating system code, applications, programs, and the like, to perform the data processing tasks associated with information handling system 500.

In the host environment, processor 502 is connected to I/O interface 510 via processor interface 506, and processor 504 is connected to the I/O interface via processor interface 508. Memory 520 is connected to processor 502 via a memory interface 522. Memory 525 is connected to processor 504 via a memory interface 527. Graphics interface 530 is connected to I/O interface 510 via a graphics interface 532 and provides a video display output 536 to a video display 534. In a particular embodiment, information handling system 500 includes separate memories that are dedicated to each of processors 502 and 504 via separate memory interfaces. An example of memories 520 and 525 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 540, disk controller 550, and I/O bridge 570 are connected to I/O interface 510 via an I/O channel 512. An example of I/O channel 512 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 510 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 540 includes BIOS/UEFI code operable to detect resources within information handling system 500, to provide drivers for the resources, initialize the resources, and access the resources. BIOS/UEFI module 540 includes code that operates to detect resources within information handling system 500, to provide drivers for the resources, to initialize the resources, and to access the resources.

Disk controller 550 includes a disk interface 552 that connects the disk controller to HDD 554, to ODD 556, and to disk emulator 560. An example of disk interface 552 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 560 permits SSD 564 to be connected to information handling system 500 via an external interface 562. An example of external interface 562 includes a USB interface, an IEEE 4394 (Firewire) interface, a proprietary interface, or a combination thereof. Alternatively, solid-state drive 564 can be disposed within information handling system 500.

I/O bridge 570 includes a peripheral interface 572 that connects the I/O bridge to add-on resource 574, to TPM 576, and to network interface 580. Peripheral interface 572 can be the same type of interface as I/O channel 512 or can be a different type of interface. As such, I/O bridge 570 extends the capacity of I/O channel 512 when peripheral interface 572 and the I/O channel are of the same type, and the I/O bridge translates information from a format suitable to the I/O channel to a format suitable to the peripheral channel 572 when they are of a different type. Add-on resource 574 can include a data storage system, an additional graphics interface, a network interface card (NIC), a sound/video processing card, another add-on resource, or a combination thereof. Add-on resource 574 can be on a main circuit board, on separate circuit board or add-in card disposed within information handling system 500, a device that is external to the information handling system, or a combination thereof.

Network interface 580 represents a NIC disposed within information handling system 500, on a main circuit board of the information handling system, integrated onto another component such as I/O interface 510, in another suitable location, or a combination thereof. Network interface device 580 includes network channels 582 and 584 that provide interfaces to devices that are external to information handling system 500. In a particular embodiment, network channels 582 and 584 are of a different type than peripheral channel 572 and network interface 580 translates information from a format suitable to the peripheral channel to a format suitable to external devices. An example of network channels 582 and 584 includes InfiniBand channels, Fibre Channel channels, Gigabit Ethernet channels, proprietary channel architectures, or a combination thereof. Network channels 582 and 584 can be connected to external network resources (not illustrated). The network resource can include another information handling system, a data storage system, another network, a grid management system, another suitable resource, or a combination thereof.

Management device 590 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 500. In particular, management device 590 is connected to various components of the host environment via various internal communication interfaces, such as a Low Pin Count (LPC) interface, an Inter-Integrated-Circuit (I2C) interface, a PCle interface, or the like, to provide an out-of-band (OOB) mechanism to retrieve information related to the operation of the host environment, to provide BIOS/UEFI or system firmware updates, to manage non-processing components of information handling system 500, such as system cooling fans and power supplies. Management device 590 can include a network connection to an external management system, and the management device can communicate with the management system to report status information for information handling system 500, to receive BIOS/UEFI or system firmware updates, or to perform other task for managing and controlling the operation of information handling system 500.

Management device 590 can operate off of a separate power plane from the components of the host environment so that the management device receives power to manage information handling system 500 when the information handling system is otherwise shut down. An example of management device 590 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 590 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a storage configured to store a machine learning (ML) model; and
a processor to communicate with the storage, the processor to:
receive first telemetry data associated with a second information handling system;
receive user survey data associated with the second information handling system;
based on the first telemetry data and the user survey data, train the ML model;
receive second telemetry data for the second information handling system; and
execute the ML model to determine a composite score for the second information handling system.

2. The information handling system of claim 1, wherein during the training of the ML model, the processor further to: correlate the first telemetry data to the first user survey data.

3. The information handling system of claim 1, wherein the processor further to: group the second information handling system into one of a plurality of groups based on the composite score.

4. The information handling system of claim 3, wherein each different one of the plurality of groups is associated with a different user experience for the second information handling system.

5. The information handling system of claim 1, wherein during the execution of the ML model, the processor further to: determine a hardware component score based on the second telemetry data.

6. The information handling system of claim 5, wherein during the execution of the ML model, the processor further to: determine an operating system and application score based on the second telemetry data.

7. The information handling system of claim 6, wherein during the execution of the ML model, the processor further to: determine a startup and boot score based on the second telemetry data.

8. The information handling system of claim 7, wherein the composite score is a weighted average of the hardware component score, the operating system and application score, and the startup and boot score.

9. A method comprising:
receiving, by a processor of a first information handling system, first telemetry data associated with a second information handling system;
based on the first telemetry data and user survey data associated with the second information handling system, training a machine learning (ML) model;
storing the trained ML model in the first information handling system;
receiving second telemetry data for the second information handling system; and
executing, by the processor, the trained ML model to determine a composite score for the second information handling system.

10. The method of claim 9, wherein during the training of the ML model, the method further comprises correlating the first telemetry data to the first user survey data.

11. The method of claim 9, wherein the method further comprises grouping the second information handling system into one of a plurality of groups based on the composite score.

12. The method of claim 11, wherein each different one of the plurality of groups is associated with a different user experience for the second information handling system.

13. The method of claim 9, wherein during the execution of the ML model, the method further comprises determining a hardware component score based on the second telemetry data.

14. The method of claim 13, wherein during the execution of the ML model, the method further comprises determining an operating system and application score based on the second telemetry data.

15. The method of claim 14, wherein during the execution of the ML model, the method further comprises determining a startup and boot score based on the second telemetry data.

16. The method of claim 15, wherein the composite score is a weighted average of the hardware component score, the operating system and application score, and the startup and boot score.

17. A method comprising:
receiving, by a processor of a first information handling system, first telemetry data associated with a second information handling system;
based on the first telemetry data and user survey data associated with the second information handling system, training a machine learning (ML) model;
storing the trained ML model in the first information handling system;
receiving second telemetry data for the second information handling system;
executing, by the processor, the trained ML model to determine a composite score for the second information handling system; and
based on the composite score, providing a remediation event for the second information handling system.

18. The method of claim 17, wherein during the training of the ML model, the method further comprises: correlating the first telemetry data to the first user survey data.

19. The method of claim 17, wherein the method further comprises: group the second information handling system into one of a plurality of groups based on the composite score.

20. The method of claim 17, wherein each different one of the plurality of groups is associated with a different user experience for the second information handling system.
